(19) United States
(12) Patent Application Publication
(10) Pub. No.: US 2018/0164564 A1
(43) Pub. Date: Jun. 14, 2018

(54) ASSEMBLY AND METHOD FOR BEAM SHAPING AND FOR LIGHT SHEET MICROSCOPY

(71) Applicant: Carl Zeiss Microscopy GmbH, Jena (DE)

(72) Inventor: Dr. Jorg SIEBENMORGEN, Jena (DE)

(21) Appl. No.: 15/577,697

(22) PCT Filed: May 25, 2016
(86) PCT No.: PCT/EP2016/061743

§ 371 Date: Nov. 28, 2017

(30) Foreign Application Priority Data
May 28, 2015 (DE) 10 2015 209 758.7

(51) Int. Cl. G02B 21/00; G02B 21/16; G02B 21/36

(52) U.S. Cl. CPC G02B 21/0032; G02B 21/0056; G02B 21/367; G02B 21/0076; G02B 21/16

(57) ABSTRACT

A beam shaping assembly has a device for generating a collimated radiation, which contains, in the beam path of the collimated radiation in a space domain a diffraction device for generating a non-diffraction-limited beam, and in a frequency domain a modification device for converting the non-diffraction-limited beam. The present invention furthermore relates to a method for beam shaping and to an assembly for light sheet microscopy. A corresponding method for beam shaping of a modified non-diffraction-limited beam and an assembly for light sheet microscopy which contains a beam shaping assembly.

### RELATED APPLICATIONS

The present application is a U.S. National Stage application of International PCT Application No. PCT/EP2016/061743 filed on May 25, 2016 which claims priority benefit of German Application No. DE 10 2015 209 758.7 filed on May 28, 2015, the contents of each are incorporated by reference in their entirety.

### FIELD OF THE INVENTION

The present invention relates to a beam shaping assembly comprising a device for generating a collimated radiation, which contains in the beam path of the collimated radiation in a spatial domain, a diffraction device for generating a non-diffraction-limited beam, and in a frequency domain a modification device for converting the non-diffraction-limited beam. The invention furthermore relates to a method for beam shaping and to an assembly for light sheet microscopy comprising a sample stage, an illumination device containing a beam shaping assembly according to the invention for generating a light sheet for illuminating a strip of a sample and exciting a fluorescence radiation, a detection device containing a sensor for detecting the fluorescence radiation, an imaging optical unit for imaging the fluorescence radiation emitted by the sample onto the sensor, and a detection axis perpendicular to the light sheet.

### BACKGROUND OF THE INVENTION

A microscope in which the illumination beam path and the detection beam path are arranged substantially perpendicular to one another and with which the sample is illuminated with a light sheet in the focal plane of the imaging or detection lens, i.e. perpendicular to the optical axis thereof, is designed for the examination of samples according to the method of selective plane illumination microscopy (SPIM), that is to say light sheet microscopy. As a result of the illumination with a light sheet, a fluorescence radiation is generated in the strip of the sample that is illuminated with the light sheet. For this purpose, the sample can contain additional dyes suitable for fluorescence. In contrast to confocal laser scanning microscopy (LSM), in which a three-dimensional sample is scanned point by point in individual planes of different depths and the image information obtained in the process is subsequently combined to form a three-dimensional imaging of the sample, SPIM technology is based on wide field microscopy and enables the sample to be represented as a visual image on the basis of optical sections through individual planes of the sample.

The advantages of SPIM technology consist, inter alia, in the higher speed at which the image information is captured, the lower risk of bleaching of biological samples and also an extended penetration depth of the focus into the sample.

One of the main applications of light sheet microscopy is in the imaging of medium-sized organisms having a size of a few 100 μm up to a few millimeters. Said organisms are generally embedded in agarose, which is in turn situated in a glass capillary. The glass capillary is introduced into a water-filled sample chamber from above or from below and the sample is forced out of the capillary a little way. The sample in the agarose is illuminated with a light sheet and the fluorescence is imaged onto a camera by a detection lens situated perpendicular to the light sheet and thus also perpendicular to the light sheet optical arrangement, as explained for example in Huisken et al. Development 136, 1963 (2009) “Selective plane illumination microscopy techniques in developmental biology” or in WO 2004/053558 A1.

This method of light sheet microscopy has three major disadvantages. Firstly, the samples to be examined are relatively large: Typical samples originate from developmental biology. Moreover, on account of the sample preparation and the dimensions of the sample chamber, the light sheet is relatively thick and the axial resolution that can be achieved is thus limited. In addition, the sample preparation is complex and incompatible with standard sample preparation and standard sample mounting in the customary way in fluorescence microscopy on cells.

In order in part to avoid these limitations, a novel light sheet microscopy set-up has been realized in recent years, in which the illumination lens and the detection lens are perpendicular to one another and are directed at the sample from above at an angle of α1 equals α2 equals 45°. Such an SPIM set-up is disclosed for example in WO 2012/110488 A2 and in WO 2012/122027 A2.

FIG. 1a schematically illustrates such an upright 45° SPIM configuration. The sample P1 is situated therein on the bottom of a Petri dish P2. The Petri dish is filled with a liquid P3, for example with water, and the two SPIM lenses, that is to say the illumination lens P4 and the detection lens P5, are dipped into the liquid P3. Such an assembly affords the advantage of a higher resolution in the axial direction since a thinner light sheet P6 can be generated. Smaller samples can also be examined on account of the higher resolution. In this case, the sample preparation has become significantly simpler. However, it is still very disadvantageous that the sample preparation and also the sample mount still do not correspond to the standard sample preparations and standard sample mounts that are customary in fluorescence microscopy on cells. Thus, the Petri dish has to be relatively large in order that the two SPIM lenses can be dipped into the liquid situated in the Petri dish, without said lenses striking the edge of the dish. Multi-well plates, which are standard in many areas of biology, cannot be used with this method since the lenses cannot dip into the very small wells of the plate. Moreover, this method has the disadvantage that e.g. high throughput screening is not readily possible, since the lenses have to be cleaned when the sample is changed, in order to avoid contamination of the different samples.

These problems are avoided by the so-called inverse 45° SPIM configuration, as illustrated in FIG. 1b. In this case, although the 45° configuration is maintained, the two SPIM lenses, that is to say the illumination lens P4 and the detection lens P5, are now no longer directed at the sample from above, rather the sample is illuminated from below through the transparent bottom of the sample mount and the fluorescence is detected. Such an assembly is disclosed in DE 10 2013 107 297 A1 and DE 10 2013 107 298 A1 in the name of the present applicant. Consequently, all typical sample mounts such as e.g. multi-well plates, Petri dishes and object carriers can be used and contamination of the samples during high throughput screening is no longer possible.

The two variants of light sheet microscopy described here have in common the fact that a light sheet is generated by means of one of the two SPIM lenses and the fluorescence is detected by means of the second of the two SPIM lenses. In this case, the image plane of the detection lens lies in the light sheet, such that the illuminated region is sharply imaged onto the detector.

Light sheet microscopy requires the generation and modeling of a corresponding beam into a so-called light sheet in order to be able to illuminate the sample by means of said light sheet, which ideally has a long length in conjunction with just a small thickness.

For illuminating a sample with a light sheet in an assembly for light sheet microscopy, non-diffraction-limited beams can be used, that is to say for example a Bessel beam, a sectioned Bessel beam or a Mathieu beam. The lateral beam profiles of a Bessel beam, of a sectioned Bessel beam and of a Mathieu beam are illustrated in FIGS. 2a-2c.

As shown in FIG. 2a, the Bessel beam has a central maximum that is narrower than the focus of a comparable Gaussian beam. The central maximum is surrounded by a multiplicity of rings. In the direction of propagation, the Bessel beam always has the same beam profile along the entire beam length. It does not change its beam profile, in particular as far as its extent in the y-direction is concerned, which is referred to hereinafter as thickness. In principle, therefore, beams of arbitrary length can be generated, without the central maximum changing in terms of its shape and formation. Only the number of rings increases with increasing beam length.

The sectioned Bessel beam, as shown in FIG. 2b and as described for example by Fahrbach et al. in “Self-reconstructing sectioned Bessel beams offer submicro optical sectioning for large fields of view in LSM”, Opt Expr, 21, 11425, 2013, is closely related to the Bessel beam. It differs from the Bessel beam in that the closed rings become half-rings. Secondary maxima form on the axis along the ring opening. In principle, the sectioned Bessel beam has the same properties as the Bessel beam. However, a significantly thinner scanned light sheet can be generated with the latter.

The Mathieu beam, as shown in FIG. 2c and as described by Gutierrez-Vega et al. in “Experimental demonstration of optical Mathieu beams”, Opt Comm, 195, 35, 2001, and in DE 10 2012 013 163 A1 and WO 2014/005682 A2, likewise has the same properties as the Bessel beam in principle, the beam profile being similar to the sectioned Bessel beam, but the Mathieu beam has no secondary maxima along the y-axis. A central maximum is surrounded by semicircular secondary maxima, the intensity of which decrease outwardly along the x-axis.

While FIG. 2c shows the lateral profile, that is to say an x-y-plane, of a Mathieu beam having a length of 100 μm, FIGS. 2d and 2d′ illustrate the beam profile of the same Mathieu beam in the direction of propagation, that is to say in an x-z-plane. The central maximum has a thickness of approximately 0.550 μm.

These beams can be generated by illuminating optical elements usually with a collimated beam generated by a laser source, for example:

for Bessel beams, the lateral beam profile (x-y-intensity profile) of which is illustrated in FIG. 2a, ring stops, axicons or SLMs are suitable as optical elements in the beam path of the homogeneous beam.

The generation of a Bessel beam with a ring stop, as described by Durnin et al. in “Diffraction-Free Beams”, Phys Rev Lett, 58, 1499, 1987, is the simplest and least expensive possibility. Beams having a high beam quality can be generated very simply. However, the power transmission of the annular aperture, annular orifice or circular aperture with a value of just a few percent is extremely low, and so this method is preferably not offered for generating Bessel beams in a commercial product.

The generation of a Bessel beam using an axicon, that is to say a rotationally symmetrical cone composed of a transparent material such as glass, for example, is described by Arimoto et al. in “Imaging properties of axicon in a scanning optical system”, Appl Opt, 31, 6653, 1992. In contrast to the annular aperture, annular orifice or circular aperture, the power transmission is approximately 100%. With an axicon it is possible to generate beams of arbitrary length, in principle, simply by increasing the diameter of the axicon.

A further possibility is to generate a Bessel beam using a spatial light modulator (SLM), as described for example by Bowman et al. in “Efficient generation of Bessel beam arrays by SLM”, Eur Phys J Spec Top, 199, 159, 2011. For this purpose, the phase pattern of an axicon is represented on an SLM. The maximum achievable beam length is determined by the size and the number of pixels of the SLM. Although an SLM is the most expensive and most complex possibility for generating Bessel beams, it offers the greatest variability. Arbitrary beam lengths and thicknesses can thus be set, within limits. A plurality of parallel beams can also be generated in a simple manner using this variant.

In order to generate a sectioned Bessel beam, the lateral beam profile (x-y-intensity profile) of which is illustrated in FIG. 2b, two opposite segments can be cut out of the ring spectrum of the Bessel beam by means of a stop. As in the generation of a Bessel beam, a sectioned Bessel beam can also be generated using an SLM or an axicon.

The generation of a Mathieu beam is more complicated than that of a Bessel beam. For this purpose, too, annular apertures, annular orifices or circular apertures axicons or SLMs are suitable as optical elements in the beam path of the homogeneous beam. FIG. 2c illustrates a lateral beam profile (x-y-intensity profile) of a Mathieu beam, and FIG. 2d shows the beam profile thereof in the direction of propagation, that is to say in an x-z-plane, wherein in FIG. 2d the position of the plane from FIG. 2c is indicated by a dashed white line. FIG. 2d′ shows an enlarged excerpt from FIG. 2d, as is indicated therein by the dashed white rectangle. The intensity spectrum of such a Mathieu beam in a pupil plane is illustrated in FIG. 2e.

In order to generate a Mathieu beam using a ring stop, the ring stop has to be illuminated with an elliptical Gaussian beam. The thickness of the elliptical Gaussian beam influences the thickness of the central maximum of the Mathieu beam and the degree of curvature of the secondary maxima. The beam length is defined by the ring thickness. The disadvantage of the annular aperture, annular orifice or circular aperture once again resides in the poor power transmission.

A Mathieu beam can also be generated using a spatial light modulator (SLM). In the most complex and also most expensive method, two SLMs are used for this purpose. The first SLM changes the incident intensity distribution such that the latter is suitable for generating a Mathieu beam. With the aid of the second SLM, the phase of said intensity distribution is then adapted, such that ultimately a Mathieu beam arises. The phase patterns which have to be coded on the SLMs for this purpose can be calculated e.g. using the Gerchberg-Saxton algorithm. Alternatively, instead of two SLMs it is possible to use one SLM having a corresponding number of pixels, as explained by Jesacher et al. in “Near-perfect hologram reconstruction with a spatial light modulator”, Opt Expr, 16, 2597, 2008. SLMs having full HD resolution have become available in the meantime. These SLMs can now be used in a double pass. The intensity will be manipulated on the first half of the SLM display, and the phase in the second half.

Since both the intensity and the phase have to be adapted for the generation of a Mathieu beam, the generation of the beam using only one SLM is possible only with concessions. This is possible for example with the aid of the modulated blazed grating method described by Davis et al. in “Encoding amplitude information onto phase-only filters”, Appl Opt, 38, 5004, 1999, wherein undesired light is simply diffracted into a different order, and the correct phase is impressed on the light passing into the correct order by means of the same SLM. The disadvantage of this method is that the power transmission is in the range of <50%.

A further possibility for generating a Mathieu beam consists in the use of an axicon.

The spectrum of the Mathieu beam in the pupil or a conjugate plane with respect thereto, as illustrated in FIG. 2e, can be calculated e.g. with:

I(vₓ,v_{y})=exp[−(vᵣ−v^{rc})²/d²]^{s}·exp(−v_{y}²/w²), (1)

where vᵣ=\sqrt{vₓ²+v_{y}²}, wherein vₓ and v_{y} represent the coordinates in the pupil, with the diameter of the ring-shaped spectrum v_{rc} for a ring width of d, with a sharpness parameter s>0 and with a thickness parameter of the Mathieu beam w. The gradient of the rise in the spectrum from zero up to a maximum intensity is represented by the “sharpness parameter” s: The greater the sharpness parameter s, the steeper said rise. For w→∞ the Mathieu beam undergoes transition to a Bessel beam.

Bipartite phase plates having a phase jump of π in the center of the plate were used by Friedrich et al. in “STED-SPIM stimulated emission depletion improves sheet Illumination microscopy resolution”, Bio Phys J, 100, L43, 2011, in order to convert a Gaussian light sheet into a light sheet having a zero. Instead of phase plates it is possible to represent equivalent phase functions on an SLM in order to carry out corresponding beam shaping, as shown by Vasilyeu et al. in “Generating superpositions of higher-order Bessel beams”, Opt Expr, 17, 23389, 2009.

The coherent superposition of Bessel beams is described by Kettunen et al. in “Propagation-invariant spot arrays”, Opt Lett, 1247, 23, 1998. The superposition is achieved by calculating with the aid of an algorithm a phase element which can be introduced into the pupil. If the spectrum of a Bessel beam is imaged into the pupil, the phase element generates a multiplicity of Bessel beams which are superposed in the sample. The phase element is similar to a star-shaped grating having the phase values 0 and π. It is specified as a condition that the distances between the individual Bessel beams must be large, since otherwise undesired interference effects can occur.

In order to generate a light sheet, these non-diffraction-limited beams described above are usually scanned. In comparison with the Bessel beam and the sectioned Bessel beam, the loading on the sample is the least in the case of the scanned Mathieu beam.

As a result of the secondary maxima of the beams, a widening of the light sheet occurs during scanning. This is illustrated in FIGS. 3a and 3b for a Bessel beam and a Mathieu beam. If a Mathieu beam having a length of 100 μm is scanned, for example, the central maximum of which has a thickness of 0.550 μm, then the resulting light sheet has a thickness of 2.5 μm. This becomes apparent in the form of reduced axial resolution and low contrast in the resulting image of the sample.

Fahrbach et al., in “Propagation stability of self-reconstructing Bessel beams enables contrast-enhanced imaging”, Nat Comm, 3, 632, 2012, present a method in which, with the aid of a slit stop, a confocal detection can be carried out in a light sheet microscope with a scanned Bessel beam. In this case, the gap width is set such that only the central maximum is imaged onto the detector and the secondary maxima are suppressed. The resulting image has an axial resolution that corresponds to the thickness of the central maximum of the Bessel beam.

A confocal detection can be carried out analogously with Mathieu beams, the higher preservation of samples being manifested here in comparison with the Bessel beam.

If a scanned Mathieu beam in conjunction with confocal detection is used in a light sheet microscope, then only the central maximum of the beam is detected by means of the slit stop. A higher parallelization, i.e. a higher number of pixels that are simultaneously exposed or active for the detection on a detector, can be achieved by widening the gap. This directly has the consequence that the axial resolution is reduced since the wider secondary maxima are then likewise detected.

### OBJECTS OF THE INVENTION

It is therefore an object of the present invention to describe an assembly and a method for beam shaping suitable for generating a light sheet having a small thickness, and to describe an assembly for light sheet microscopy which enables a high parallelization during detection, without the axial resolution being detrimentally affected thereby.

This object is achieved by means of a beam shaping assembly as claimed in claim 1 or as claimed in claim 5, by means of a method for beam shaping as claimed in claim 11 and by means of an assembly for light sheet microscopy as claimed in claim 13.

A beam shaping assembly comprises a device for generating a collimated radiation, which contains a light source for generating a collimated radiation, or which contains a light source for generating a non-collimated radiation and, downstream of the light source, a device for collimating the radiation. Such a device for generating a collimated radiation thus generates collimated light aligned in a defined manner.

In the beam path of said collimated radiation the beam shaping assembly furthermore contains a diffraction device arranged in a spatial domain and configured such that it generates a non-diffraction-limited beam by diffraction of the collimated radiation incident in the diffraction device.

Furthermore, the beam path of the collimated radiation emitted by the device for generating a collimated radiation contains an optically collecting function for the Fourier transformation and mapping of the non-diffraction-limited beam into a frequency domain. Said collecting function is realized either likewise by the diffraction device or else by the arrangement of a collecting optical unit containing at least one collecting optical element and disposed downstream of the diffraction device. Said collecting optical unit or one element or a plurality of elements of said collecting optical unit thus serve(s) for mapping the non-diffraction-limited beam into a frequency domain, wherein said mapping can be described mathematically by a Fourier transformation. A sequence of a plurality of Fourier transformations and inverse Fourier transformations is also possible in order to correspondingly shape the beam and to prevent undesired effects.

A modification device is arranged in the frequency domain disposed downstream of the diffraction device, such as in other words in the pupil of the collecting optical unit, into which frequency domain the diffraction-limited beam, or more precisely the spectrum of the diffraction-limited beam, is mapped for example by means of lenses. Said modification device is configured for converting the non-diffraction-limited beam into a modified non-diffraction-limited beam.

Finally, the beam shaping assembly contains a further optically collecting function for the inverse Fourier transformation of the spectrum of the modified non-diffraction-limited beam from the frequency domain. This collecting function, too, can in turn be implemented either by the modification device itself or else by a further collecting optical unit disposed downstream of the modification device and comprising at least one collecting optical element. With the aid of said collecting optical unit, the modified non-diffraction-limited beam is transformed back from the frequency domain by means of inverse Fourier transformation of the spectrum of the modified non-diffraction-limited beam and at this juncture can then be further optimized or supplied for the use of said beam.

According to the invention, then, the modified non-diffraction-limited beam contains N primary maxima, wherein N is a natural number greater than or equal to 2, along a straight line perpendicular to the direction of propagation of the modified non-diffraction-limited beam. Thus, if an x-y-plane in the region of the modified non-diffraction-limited beam is considered, i.e. a plane perpendicular to the direction of propagation of the modified non-diffraction-limited beam, which runs along the z-direction, then at least two primary maxima occur therein along a straight line, preferably along the x-axis. In this case, a primary maximum is defined as that position along all positions within the x-y-plane at which a maximum radiation intensity is present. If there are a plurality of positions having identical maximum radiation intensities, then a plurality of primary maxima are present. In contrast to the primary maximum, a secondary maximum is defined as a position at which the radiation intensity contains a local maximum in comparison with its closest surroundings, but that has a lower radiation intensity than the primary maximum.

Since the primary maxima, in comparison with the secondary maxima, have a smaller extent in a direction perpendicular to the straight line along which the primary maxima are formed—that is to say preferably a smaller extent in the y-direction—it is thus possible to employ a high axial resolution whilst simultaneously using a plurality of maxima of the modified non-diffraction-limited beam for generating a light sheet which for example is intended to be used for illuminating a sample in a device or in a method of light sheet microscopy. Such a beam shaping assembly is thus suitable for very rapidly generating a light sheet of very small thickness.

This becomes clear in particular if FIGS. 8 c-d, which show the intensity profiles in an x-y-plane of Mathieu beams modified by means of different phase functions, are compared with FIG. 8a, which shows the intensity profile of a non-modified Mathieu beam, and with FIGS. 2a and 2b, which show the intensity profiles of two further non-modified non-diffraction-limited beams—of a Bessel beam and of a sectioned Bessel beam.

In a consideration analogous to FIGS. 3a and 3b in respect of the behavior of such a beam for example respectively during the scanning of its primary maximum or of its primary maximum and adjacent secondary maxima in the case of a non-modified non-diffraction-limited beam or else of its plurality of primary maxima in the case of a modified diffraction-limited beam, the benefit of using the plurality of primary maxima of a modified non-diffraction-limited beam for the axial resolution becomes clear in a visual image. In other words, if for a higher parallelization and thus for a higher examination speed a plurality of maxima of a non-diffraction-limited beam are intended to be used for generating a light sheet, than a prior modification of the non-diffraction-limited beam in such a way that a plurality of primary maxima are generated along a straight line perpendicular to the propagation direction of the beam affords a considerable advantage for the axial resolution of the structures of a sample illuminated with such a light sheet.

In this case, the resolution or the resolving power denotes the distinguishability of fine structures, that is to say e.g. the smallest distance still perceptible between two punctiform objects. In the examination of a sample with a light sheet that was generated by a non-diffraction-limited beam modified according to the invention, with a high examination speed through the use of a plurality of primary maxima of the modified non-diffraction-limited beam the capability enabling directly adjacent structures still to be perceived as different structures is thus significantly higher than with the use of the primary maximum and corresponding adjacent secondary maxima of a non-modified non-diffraction-limited beam.

In one advantageous embodiment, the diffraction device of the beam shaping assembly according to the invention contains an annular aperture, annular orifice or circular aperture, an axicon or a spatial light modulator (SLM). The diffraction device serves firstly for generating the non-diffraction-limited beam. This can be effected, as described above, in a simple manner using a ring stop or an axicon. By contrast, a diffraction device containing a spatial light modulator constitutes a more cost-intensive solution. However, the use of a spatial light modulator offers significantly further-reaching possibilities for generating an optimum non-diffraction-limited beam and also for the “further processing” thereof. A spatial light modulator can perform for example the function of a multiplicity of optical elements, that is to say that the spatial light modulator can be inserted into the beam path of the light instead of said elements or even instead of a combination of different elements from among said optical elements.

A beam shaping assembly is furthermore advantageous which comprises a modification device containing a phase element, into which a phase function for generating a modified non-diffraction-limited beam having N primary maxima along a straight line perpendicular to the direction of propagation of the modified non-diffraction-limited beam is coded. Preferably, said phase element is formed by a phase plate or a spatial light modulator.

While a phase plate constitutes a simple, albeit not very variable possibility for a modification device, a spatial light modulator offers comprehensive adaptation possibilities. In this regard, with the use of a spatial light modulator, for example, at least one phase change of the light incident in the spatial light modulator can be variable by means of a control unit, wherein the control unit is configured to vary the spatial light modulator at least with regard to the setting of the phase modulation. Alongside the control of the spatial light modulator, such a control unit can, of course, also be configured additionally to control other elements of the assembly for generating a light sheet or else elements of a superordinate device into which the beam shaping assembly is integrated.

As an alternative to a function as a pure phase element, a spatial light modulator which is contained in the modification device or which forms the modification device can also be formed as a complex-valued spatial light modulator, that is to say as a spatial light modulator which can vary both the phase and the intensity or amplitude of the incident light.

In one particular embodiment of the beam shaping assembly according to the invention, the modification device is configured for converting the non-diffraction-limited beam into a modified non-diffraction-limited beam having N primary maxima along a straight line perpendicular to the direction of propagation of the modified non-diffraction-limited beam, wherein N in this particular embodiment represents a natural number greater than or equal to 100. Depending on the possibilities afforded for configuration for example of the number of pixels of detectors or light modulators used, a significantly greater N can also be chosen, however, for example N greater than or equal to 500 or N greater than or equal to 1000. The non-diffraction-limited beam is present in the form of a spectrum at the location of the modification device, that is to say in the frequency domain. In this particular embodiment of the beam shaping assembly according to the invention, then, a stop for covering half a pupil is furthermore arranged in the frequency domain, for example in the pupil. In such an assembly with very large N, that is to say a very large number of primary maxima, generating a light sheet does not necessitate scanning the modified non-diffraction-limited beam, since the beam cross section has no structuring in the x-direction, but at the same time is extended over a very large region in the x-direction.

An alternative beam shaping assembly comprises a device for generating a collimated radiation, a device which is thus configured for generating a collimated radiation, wherein such a device contains either a light source for generating a collimated radiation or a light source for generating a non-collimated collimated radiation and, downstream of the light source, a device for collimating the radiation. The alternative beam shaping assembly furthermore contains in the beam path of the collimated radiation a diffraction and modification device arranged in a spatial domain and preferably comprising a spatial light modulator (SLM). Said diffraction and modification device is configured for generating a modified non-diffraction-limited beam—without the intermediate step of generating a non-diffraction-limited beam—and for the Fourier transformation thereof into a frequency domain.

Furthermore, said alternative beam shaping assembly contains in the beam path a collecting function for the inverse Fourier transformation of the modified non-diffraction-limited beam from the frequency domain, which is implemented either likewise by the diffraction and modification device or by a collecting optical unit disposed downstream of the diffraction and modification device and containing at least one collecting optical element.

According to the invention, then, in said alternative beam shaping assembly, too, the modified non-diffraction-limited beam, for the generation of which the diffraction and modification device is configured, contains N primary maxima, wherein N is a natural number greater than or equal to 2, along a straight line perpendicular to the direction of propagation of the modified non-diffraction-limited beam.

Advantageously, an assembly according to the invention in both alternatives for generating a light sheet furthermore contains a scanner for scanning the modified non-diffraction-limited beam, whereby a light sheet with a desired width is generated. The beam is scanned in a direction which is parallel to the straight line along which the N primary maxima are arranged, and which is perpendicular to the direction of propagation. In general, the modified non-diffraction-limited beam is thus scanned along an x-direction.

Such a scanner is not necessary if a very large number of primary maxima are employed and a stop for covering half the pupil is contained in the frequency domain.

The non-diffraction-limited beam in the beam shaping assembly can be for example a Bessel beam, a sectioned Bessel beam or a Mathieu beam. The Mathieu beam, in particular, already exhibits an intensity profile that is advantageous for the generation of a light sheet before the modification, which intensity profile, by means of a modification in which a number N of primary maxima are generated along a straight line perpendicular to the direction of propagation, is influenced once again advantageously in such a way that its extent in a direction perpendicular to the straight line along which the primary maxima are arranged, and perpendicular to the direction of propagation, is once again reduced.

A device for generating a collimated radiation which comprises a laser module containing in turn a laser source is one particularly advantageous and frequently used variant of the beam shaping assembly according to the invention. Laser radiation is used in many applications for illumination if a collimated radiation is desired for this purpose.

It is advantageous if the beam shaping assembly comprises means for illuminating the diffraction device, which shapes the beam coming from the device for generating a collimated radiation such that a homogeneous illumination of the diffraction device is achieved. In one embodiment, the means for illuminating contain lens elements that correspondingly expand the beam emitted from the device for generating a collimated radiation. The use of two lens elements is preferred in this case. However, it is also possible to use, instead of the lens elements, optical elements that can simulate the effect of lens elements.

It is furthermore advantageous if the beam shaping assembly contains a stop for filtering undesired light in the frequency domain upstream of the modification device or in a further frequency domain upstream of the modification device, or else in a frequency domain of the diffraction and modification device. This allows, for example, an undesired zero order to be filtered out.

### SUMMARY OF THE INVENTION

A method according to the invention for beam shaping, in particular for generating a light sheet for light sheet microscopy, contains the following steps:

A non-diffraction-limited beam is generated by means of a diffraction device in the beam path of a collimated radiation.

The non-diffraction-limited beam is transformed by a Fourier transformation into a frequency domain. This can be the pupil or a correspondingly conjugate plane. The intensity distribution of the non-diffraction-limited beam, that is to say the spectrum thereof, is determined in the frequency domain, that is to say in the pupil or the correspondingly conjugate plane.

The intensity distribution of the modified non-diffraction-limited beam in the frequency domain is determined by forming the sum of N complex-valued functions which consist of the intensity distribution of the non-diffraction-limited beam multiplied by the phase function of a wedge. The phase function of the wedge is increased here in each summand.

A phase function of the modified non-diffraction-limited beam in the frequency domain is determined as the argument of the intensity distribution of the modified non-diffraction-limited beam in the frequency domain.

The modified non-diffraction-limited beam is generated by coding the phase function into a modification device situated in the frequency domain.

Preferably, the modified non-diffraction-limited beam is scanned in order to generate a light sheet of corresponding width. Scanning of the modified non-diffraction-limited beam is thus desirable in most cases. However, if a modified non-diffraction-limited beam having a very large number of primary maxima N is generated and, moreover, the pupil or a correspondingly conjugate plane is covered on half its side, then the scan process is unnecessary since the modified non-diffraction-limited beam thus generated then has no structuring in the x-direction, but is still correspondingly thin in the y-direction. This is usually the case for N greater than or equal to 100, in particular for N greater than or equal to 500.

The thickness of the modified diffraction-limited beam can be influenced by a corresponding setting of the thickness of the non-modified diffraction-limited beam.

An assembly for light sheet microscopy comprises a sample plane for arranging a sample. Said sample plane can be implemented by a sample stage for placing or else for placing and fixing the sample. However, the sample plane can also be determined by a sample chamber or a mount in which a sample is held in a fixed position by fixing for example in an opening of said sample chamber or in the mount and a sample plane is thus defined. It is configured in such a way that a sample situated in the sample plane can be illuminated without shading being generated in a central part of the sample by the set-up of, for example, a sample stage, a sample chamber or other kinds of sample mount, and in such a way that the radiation emitted by the sample can be detected likewise without obstruction. The sample plane is thus arranged such that no obstruction arises in the optical path of the assembly for light sheet microscopy. That is achieved either by the choice of a suitable, optically transparent material for the sample stage, the sample chamber or the sample mount, or at least for those parts thereof which are situated in or near the optical path, or by corresponding openings in the sample stage, sample chamber or sample mount for example in such a way that the sample, an object carrier or a sample vessel is directly illuminated and that radiation emitted by the sample is directly detectable. The sample plane can furthermore be configured in a movable fashion, such that its position in space is variable in at least one direction, preferably in two or three directions in space, which can be realized for example by a movement of the sample stage, the sample chamber or the sample mount. The sample can be prepared to support a fluorescence radiation from the sample upon illumination with a corresponding light, and it can be situated in a transparent vessel or else on an object carrier, for example on one or between two transparent plates, such as two glass plates, for example.

In order to generate the light sheet, the illumination device contains a beam shaping assembly described above. In this case, the illumination device is arranged such that with the light sheet generated a strip of a sample arranged in the sample plane is illuminated and excites a fluorescence radiation there. It is advantageous if the light sheet with which the sample in the sample plane is illuminated passes non-parallel to the sample plane.

The strip that arises as a result of such a set-up in the sample, which strip is illuminated, is very narrow. It typically has thicknesses of 0.2 μm to 10 μm, in particular thicknesses of 0.4 to 1.5 μm.

Finally, the assembly for light sheet microscopy comprises a detection device having a sensor, that is to say having a detector or a detection means that is able to detect the fluorescence radiation emitted by the sample. Preference is given here to an area sensor, or an otherwise spatially resolving detection means, for the spatially resolved detection of the fluorescence radiation.

Furthermore, the detection device contains an imaging optical unit for imaging the fluorescence radiation emitted by the sample into a detection plane of the sensor. In this case, the detection plane is the plane in which the signals of the imaging are made available in the form in which they are intended to be detected by the sensor.

The detection device comprises a detection axis. Said detection axis together with the light sheet forms an angle from an angular range of 70° to 110°, preferably from an angular range of 80° to 100°. An assembly in which the detection device comprises a detection axis perpendicular to the light sheet is particularly preferred.

Advantageously, the assembly for light sheet microscopy is configured for implementing a relative movement between sample and light sheet. This enables a movement of the illuminated strip in the sample.

In one advantageous configuration of the assembly for light sheet microscopy, the detection device thereof contains a stop that is used to enable a confocal detection.

Such a stop for confocal detection in an assembly for light sheet microscopy can be formed as a “rolling shutter” on the sensor.

In this case, a “rolling shutter” denotes the read-out process of an “active pixel” image sensor, using CMOS or sCMOS technology, that is to say using complementary metal oxide semiconductor technology or using scientific CMOS technology. In contrast to the CCD sensor, the pixels of these sensors are activated and read line by line or column by column, such that the respective light-sensitive part of the area sensor is formed only by a narrow sensor strip that passes rapidly over the sensor region within an image exposure.

### BRIEF DESCRIPTION OF THE DRAWINGS

The present invention will now be explained on the basis of exemplary embodiments. In the figures:

FIG. 1a shows an upright light sheet microscope in a 45° configuration according to the prior art, and FIG. 1b shows an inverse light sheet microscope in a 45° configuration according to the prior art, as described above;

FIG. 2a shows an x-y-intensity profile of a Bessel beam;

FIG. 2b shows an x-y-intensity profile of a sectioned Bessel beam;

FIG. 2c shows an x-y-intensity profile of a Mathieu beam;

FIG. 2d shows the beam profile of said Mathieu beam in the direction of propagation, that is to say in an x-z-plane;

FIG. 2d′ shows an enlarged excerpt from FIG. 2d;

FIG. 2e shows an intensity spectrum of such a Mathieu beam in a pupil plane;

FIGS. 3a and 3b show an illustration of the intensity in an x-y-plane of a scanned Bessel beam and of a scanned Mathieu beam for light sheet generation according to the prior art;

FIG. 4 shows a first exemplary embodiment of a beam shaping assembly according to the invention;

FIG. 5 shows a second exemplary embodiment of a beam shaping assembly according to the invention;

FIG. 6 shows a third exemplary embodiment of a beam shaping assembly according to the invention;

FIG. 7 shows a fourth exemplary embodiment of a beam shaping assembly according to the invention;

FIG. 8a shows the x-y-beam profile of a Mathieu beam;

FIGS. 8b to 8d show the x-y-beam profile of a modified Mathieu beam having 2, 3 and 50 primary maxima, respectively;

FIG. 8e shows the invariant phase function in the pupil for a non-modified Mathieu beam having one primary maximum;

FIGS. 8f to 8h show the phase functions in the pupil with the aid of which the modified Mathieu beams having 2, 3 and 50 primary maxima, respectively, from FIGS. 8b to 8d are generated;

FIG. 8i shows the spectrum of the Mathieu beam, that is to say the intensity thereof in the pupil;

FIGS. 8k to 8m show the spectra of the modified Mathieu beams having 2, 3 and 50 primary maxima, respectively, from FIGS. 8b to 8d;

FIG. 9 shows a first exemplary embodiment of an assembly for light sheet microscopy according to the invention;

FIG. 10 shows a second exemplary embodiment of an assembly for light sheet microscopy according to the invention; and

FIG. 11 shows a third exemplary embodiment of an assembly for light sheet microscopy according to the invention.

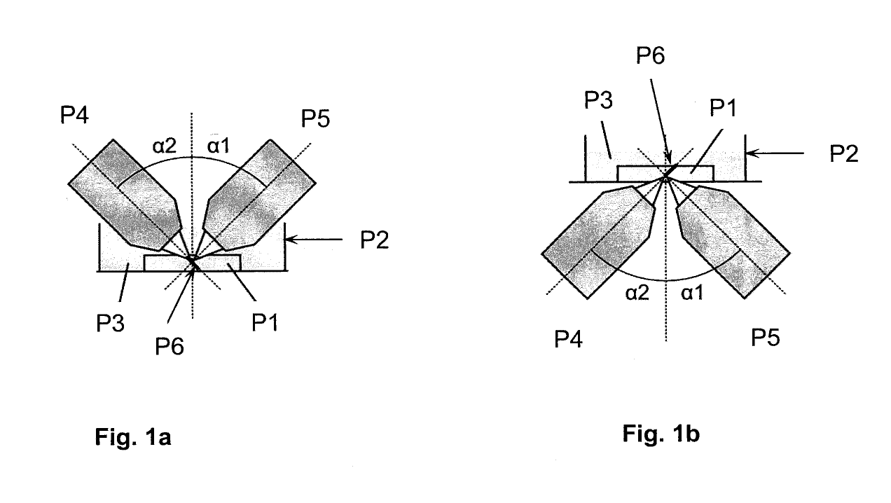

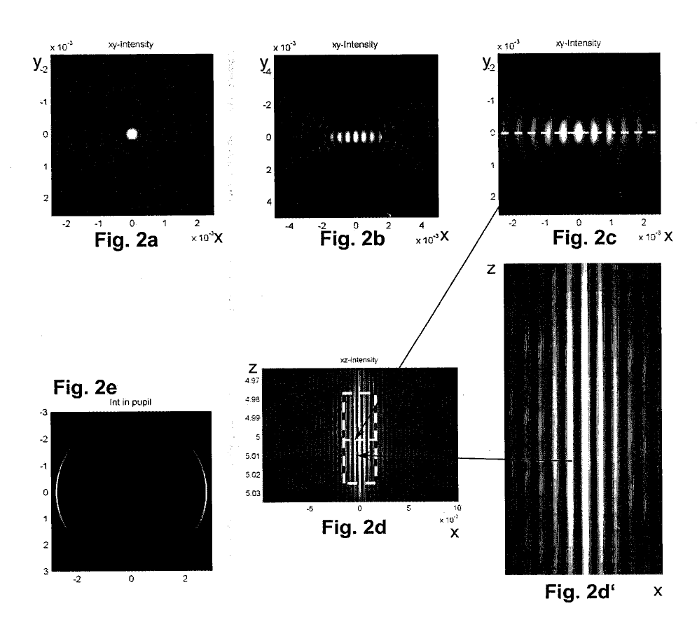

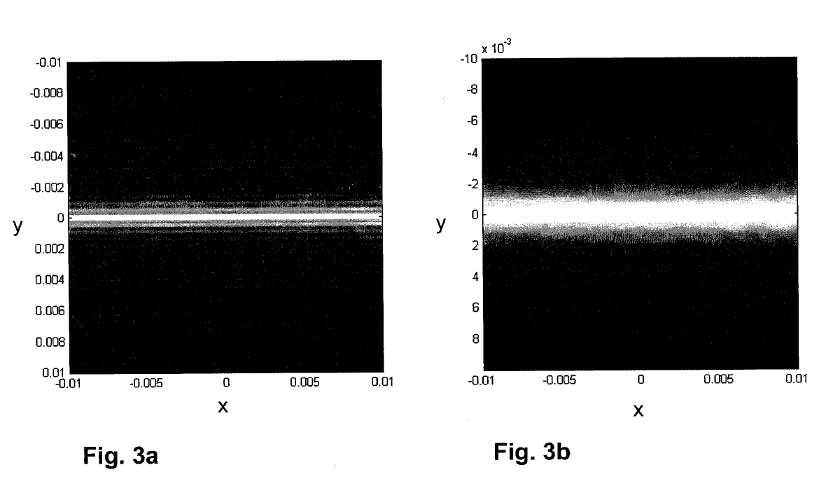

### DESCRIPTION OF THE INVENTION

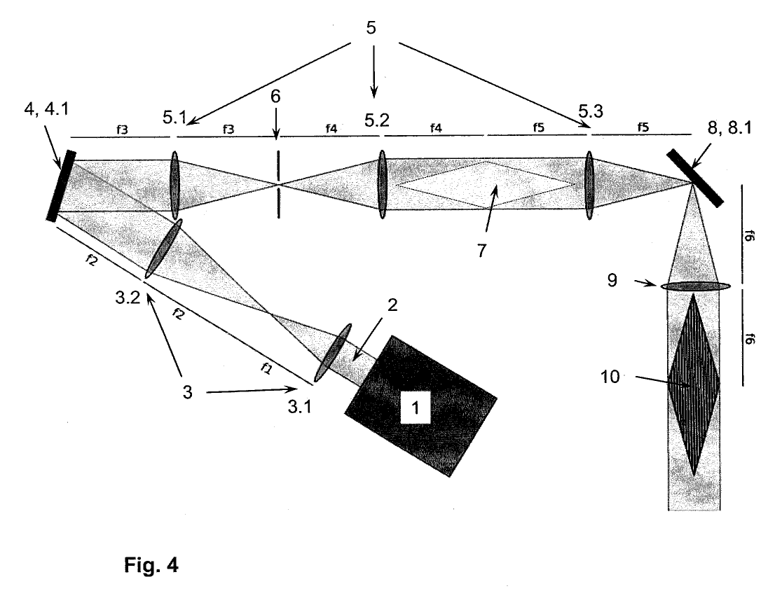

FIG. 4 illustrates a first exemplary embodiment of a beam shaping assembly according to the invention. A laser module 1 emits a Gaussian laser beam 2. Said laser beam 2 is expanded by a means for illuminating 3 the diffraction device, said means comprising the lenses 3.1 and 3.2, such that the entire diffraction device 4, which contains a spatial light modulator (SLM) 4.1 in this exemplary embodiment, is illuminated. The Gaussian laser beam 2 is converted into a Mathieu beam 7 by the spatial light modulator 4.1. Part of a collecting optical unit 5, in this case the lens 5.1 contained therein, generates the Fourier transformation, such that the spectrum of the Mathieu beam 7 can be seen in the stop plane 6. With the aid of the stop 6, a filtering is carried out in order to suppress undesired light, e.g. the zero order of the spatial light modulator (SLM) 4.1. The lenses 5.2 and 5.3 image the filtered spectrum onto a modification device 8, wherein the modification device 8 is arranged in a frequency domain and contains a second spatial light modulator (SLM) 8.1. With the aid of the modification device 8, that is to say here with the aid of the second spatial light modulator 8.1, into which a phase function for generating a modified Mathieu beam having N primary maxima (N≥2) along an x-direction is coded, the Mathieu beam 7, or more precisely the spectrum of the Mathieu beam 7, is converted into the spectrum of a modified Mathieu beam 10 having corresponding N primary maxima. With a further collecting optical unit, here with the lens 9, the spectrum of the modified Mathieu beam generated in the frequency domain of the SLM 8.1 is converted into a modified Mathieu beam 10 having N primary maxima. The modified Mathieu beam 10 can then be supplied for its use at this juncture.

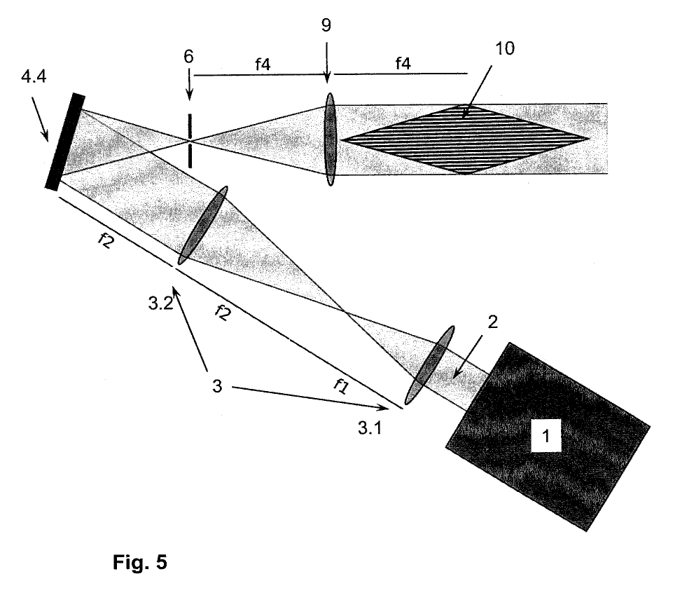

FIG. 5 shows a second exemplary embodiment of a beam shaping assembly according to the invention. A laser module 1 emits a Gaussian laser beam 2. Said laser beam 2 is expanded by the lenses 3.1 and 3.2 in order thus to illuminate a diffraction and modification device, which contains a spatial light modulator (SLM) 4.4, uniformly over the entire area thereof. By means of the spatial light modulator (SLM) 4.4, the Gaussian laser beam 2 is converted into the spectrum of a modified Mathieu beam having N primary maxima (N≥2) along an x-direction in the position of the stop 6. In this case, therefore, a function is coded in the SLM in such a way that the generation and modification of a Mathieu beam having N primary maxima (N≥2) along an x-direction can be effected simultaneously. With the aid of the stop 6, a filtering is carried out in order to suppress undesired light, e.g. the zero order of the SLM. With a collecting optical unit comprising a lens 9, the spectrum of the modified Mathieu beam is converted into a modified Mathieu beam 10.

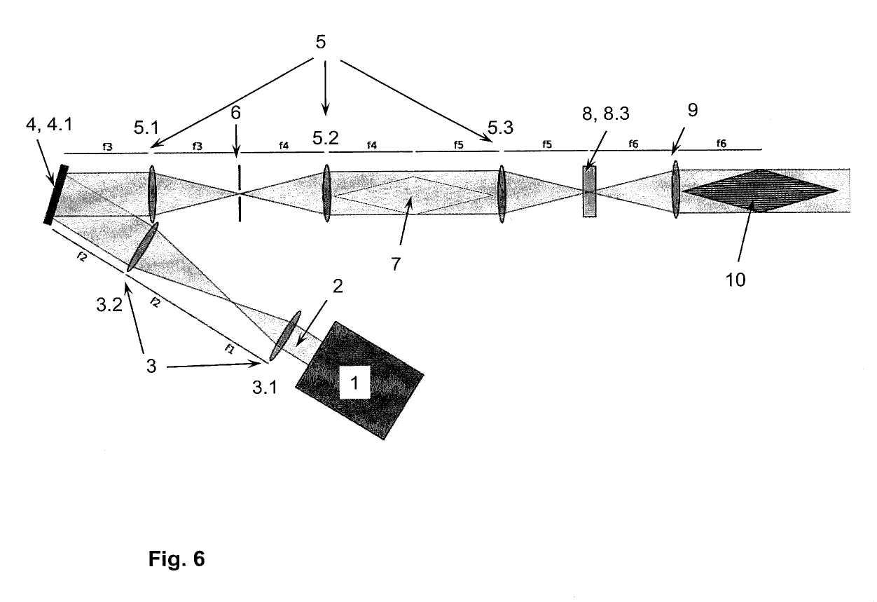

FIG. 6 illustrates a third exemplary embodiment of a beam shaping assembly according to the invention. As already described in the first exemplary embodiment, a laser module 1 emits a Gaussian laser beam 2. Said laser beam 2 is expanded by a means for illuminating the diffraction device 3 comprising the lenses 3.1 and 3.2, such that the entire diffraction device 4, which contains a spatial light modulator (SLM) 4.1 in this exemplary embodiment, is illuminated. The Gaussian laser beam 2 is converted into a Mathieu beam 7 by means of the spatial light modulator 4.1. Part of a collecting optical unit 5, in this case the lens 5.1 contained therein, generates the Fourier transformation, such that the spectrum of the Mathieu beam 7 can be seen in the stop plane 6. With the aid of the stop 6, a filtering is carried out in order to suppress undesired light, e.g. the zero order of the spatial light modulator (SLM) 4.1. The lenses 5.2 and 5.3 image the filtered spectrum onto a modification device 8, wherein the modification device 8 is arranged in a frequency domain. Said modification device now contains a phase plate 8.3 in the third exemplary embodiment. With the aid of said phase plate 8.3, the spectrum of the Mathieu beam 7 is converted into the spectrum of a modified Mathieu beam 10 having N primary maxima (N≥2) along an x-direction. With a further collecting optical unit, here with the lens 9, the spectrum of the modified Mathieu beam generated in the frequency domain by the phase plate 8.3 is converted into a modified Mathieu beam 10 having N primary maxima (N≥2) along an x-direction. The modified Mathieu beam 10 can then in turn be supplied for its use at this juncture.

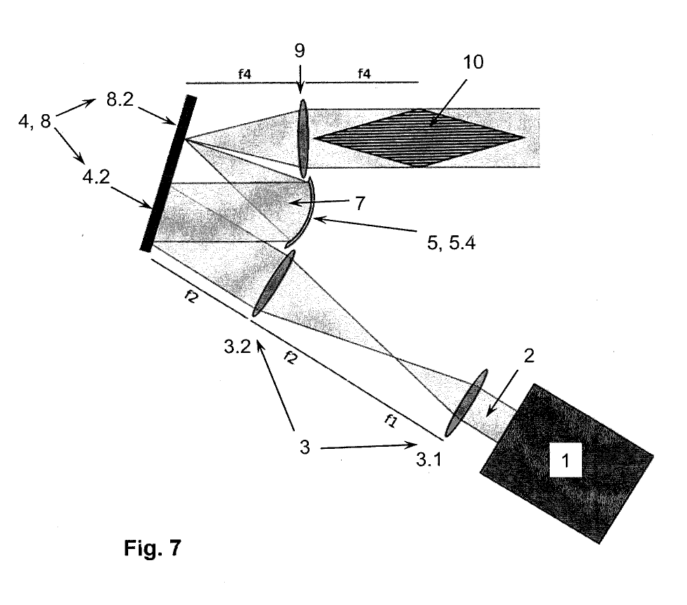

FIG. 7 illustrates a fourth exemplary embodiment of a beam shaping assembly according to the invention. Here, too, a laser module 1 emits a Gaussian laser beam 2. Said laser beam 2 is expanded by the lenses 3.1 and 3.2, such that a first half 4.2 of a spatial light modulator (SLM) 4, 8 is illuminated by this expanded laser beam 2. With the aid of this first half of the SLM 4.2, the Gaussian laser beam 2 is converted into a Mathieu beam 7. The collecting optical unit 5, which contains a curved mirror 5.4 in this exemplary embodiment, generates the Fourier transformation of the Mathieu beam 7, such that the spectrum of the Mathieu beam 7 can be seen upon entry into the second half 8.2 of the spatial light modulator (SLM) 4, 8. The second half of the SLM 8.2 converts the spectrum of the Mathieu beam 7 into a spectrum of a modified Mathieu beam 10 having N primary maxima (N≥2) along an x-direction. With a collecting optical unit containing the lens 9, the spectrum of the modified Mathieu beam 10 is converted into a modified Mathieu beam 10 having N primary maxima (N≥2) along an x-direction.

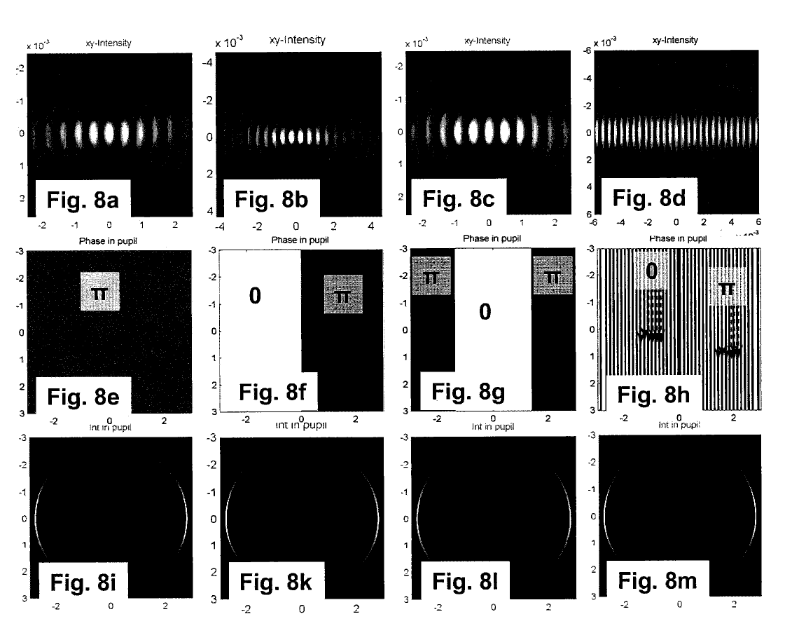

FIG. 8a shows the x-y-beam profile of a non-modified Mathieu beam 7, for which, as illustrated in FIG. 8e, no changing phase values are coded in the pupil either. FIG. 8i shows the spectrum of the non-modified Mathieu beam 7, that is to say the intensity thereof in the pupil.

In comparison therewith, FIGS. 8b to 8d show the x-y-beam profile of a modified Mathieu beam having respectively 2, 3 and 50 primary maxima. FIGS. 8f to 8h respectively illustrate the phase function in the pupil with the aid of which the modified Mathieu beam having respectively 2, 3 and 50 primary maxima from FIGS. 8b to 8d is generated. In this case, the phase values change between 0 and π depending on the position in the x-y-plane, wherein in each case a strip running parallel to the y-direction has identical phase values and an adjacent strip running parallel to the y-direction in turn has identical phase values within the strip, which differ from the phase values of their neighboring strips. As the number of primary maxima N increases, these strips having identical phase values become narrower and narrower.

FIGS. 8k to 8m show the respective spectrum of the modified Mathieu beams having 2, 3 and 50 primary maxima, respectively, from FIGS. 8b to 8d.

In order thus to achieve a higher parallelization without reducing the axial resolution, the Mathieu beam 7 can be modified with the aid of relatively simple phase masks that are coded in the modification device. In the case of the modified Mathieu beam having 2 primary maxima, both of the primary maxima are of the same thickness, i.e. their extent in the y-direction is of the same magnitude, as the central primary maximum of a non-modified Mathieu beam. In the case of more than two maxima, the thickness thereof also increases. In principle, as many primary maxima as desired can be generated. However, since the thickness of the primary maxima increases, the axial resolution becomes poorer if such a modified Mathieu beam is used for example for illuminating a sample in light sheet microscopy. This cannot be circumvented by means of a confocal gap detection. It is appropriate here, instead of a gap detection, to have recourse to the structured illumination with corresponding algorithms in order thus to obtain a high axial sectioning.

The phase function of the modified Mathieu beam having 2 primary maxima is determined as follows:

φ_{modified}(υₓ,υ_{y})=π·H(υₓ), (2)

with the Heaviside unit step function H(υᵣ).

This phase pattern constitutes an exception since, in contrast to the method described below, it need not be adapted to the beam, but rather can be used for arbitrary Mathieu beams.

The phase function of the modified Mathieu beam having an arbitrary number of primary maxima, but more than two thereof, is determined as follows:
1. A non-modified Mathieu beam having the desired properties, in particular with regard to its thickness, is generated.
2. The intensity distribution I_{Mathieu} in the pupil or in the corresponding conjugate plane of the non-modified Mathieu beam is determined.
3. The spectrum of the modified Mathieu beam in the pupil is calculated using:

I_{modified}=I_{Mathieu} (3)

φ_{modified}(υₓ,υ_{y})=arg{Σ_{j=-N/2}^{N/2}I_{Mathieu}·exp(i·υₓ·j·Δtilt)} (4)

wherein I_{modified} indicates the intensity distribution of the modified Mathieu beam, φ_{modified} indicates the phase in the pupil or in a corresponding conjugate plane, υₓ and υ_{y} indicates the frequency coordinates and N indicates the number of primary maxima which are arranged along a straight line perpendicular to the direction of propagation of the modified Mathieu beam, with the width of the light sheet thereby being determined. The greater N is, the wider the light sheet and the more primary maxima exist. Δtilt indicates the magnitude of the distance between the N primary maxima in the sample. If the distance between the individual primary maxima is very small, then interference of the partial beams assigned to the respective primary maxima occurs. By way of the parameter Δtilt, the distance between the adjacent primary maxima of the Mathieu beam is adapted. Δtilt has to be adapted here until the optimum beam profile has been found.
4. The thickness of the Mathieu beam w (see equation (1)) is adapted in order to reduce the intensity and also the number of the secondary maxima. The smaller w is chosen to be, the fewer secondary maxima there are in the detection direction, but at the same time the light sheet becomes thicker, that is to say that the extent of the light sheet in a direction y running perpendicular to the direction of propagation of the light sheet becomes greater.

If a spatial light modulator (SLM) is used, then instead of the phase function in principle it is also possible to use the spectrum, that is to say the intensity distribution in the pupil or a conjugate plane I_{modified}. In that case, however, besides the phase it is also necessary to shape the intensity or the amplitude correspondingly by means of the spatial light modulator, that is to say that corresponding phase and amplitude values have to be coded into the SLM.

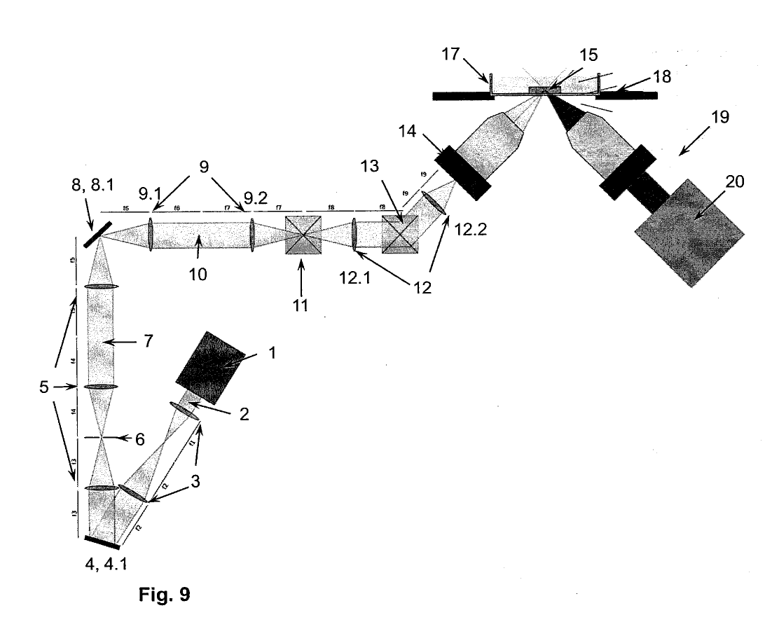

FIG. 9 shows a first exemplary embodiment of an assembly for light sheet microscopy according to the invention. The illumination device in this exemplary embodiment here uses a beam shaping assembly as described in the example in FIG. 4. The beam shaping is thus achieved, inter alia, by means of two spatial light modulators. If the modified Mathieu beam is then shaped correspondingly, the spectrum of the modified Mathieu beam 10 is imaged onto an xy-scanner 11 here by the lenses 9.1 and 9.2 of the further collecting optical unit 9. In this case, such a scanner can also be ascribed to the beam shaping assembly. The combination of lens 12.1 and tube lens 12.2 images the spectrum of the modified Mathieu beam 10 via a deflection mirror 13 once again into the pupil of the illumination objective 14. A strip of a sample 15 situated on a water-filled object carrier 17 in a sample plane, in this case on a sample stage 18, is then illuminated with such a scanned modified Mathieu beam. The fluorescence excited by the modified Mathieu beam in the illuminated strip of the sample 15 is forwarded into a detection device 19, which contains a sensor 20, by means of a detection objective. With the aid of the detection device 19, an image is recorded and forwarded to a computer.

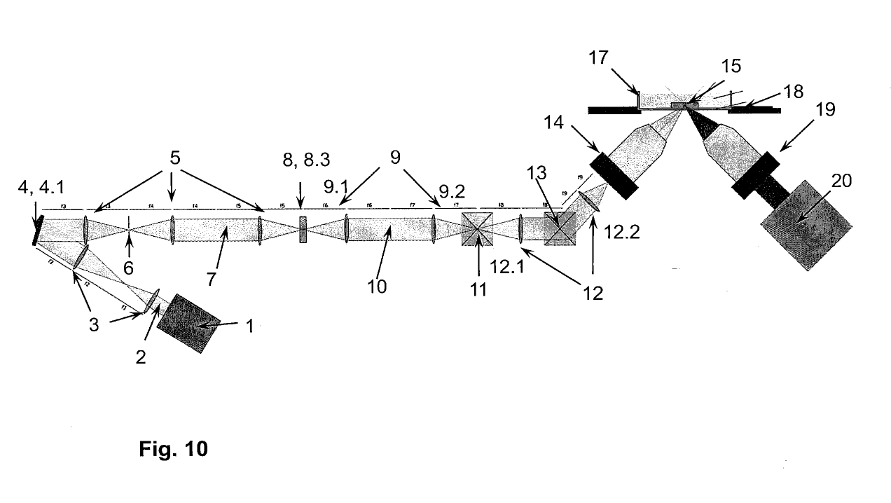

FIG. 10 illustrates a second exemplary embodiment of an assembly for light sheet microscopy according to the invention. The illumination device in this exemplary embodiment uses a beam shaping assembly as described in the example in FIG. 6. In this case, the beam is achieved with the aid of a spatial light modulator and also a phase plate. The combination of lens 12.1 and tube lens 12.2 images the spectrum of the modified Mathieu beam 10 with the aid of a deflection mirror 13 once again into the pupil of the illumination objective 14. A strip of a sample 15 situated on a water-filled object carrier 17 in a sample plane, in this case on a sample stage 18, is then illuminated with such a scanned modified Mathieu beam 10. The detection device in this exemplary embodiment corresponds in terms of set-up and procedure to that in the exemplary embodiment in FIG. 9.

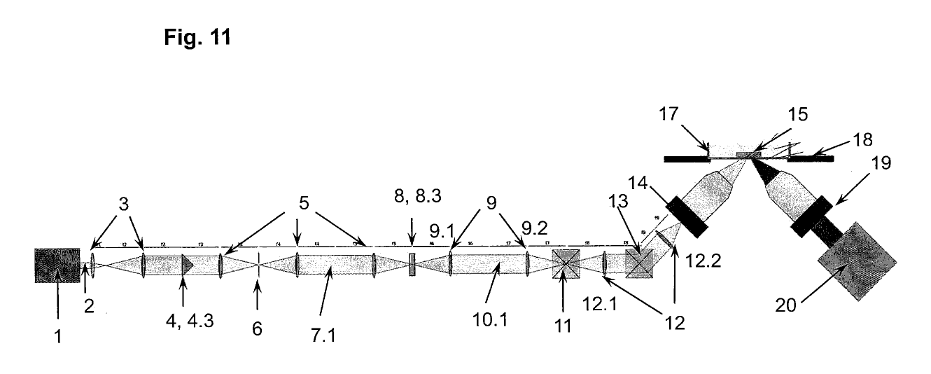

FIG. 11 finally shows a third exemplary embodiment of an assembly for light sheet microscopy according to the invention. A beam shaping assembly corresponding to none of the exemplary embodiments described in FIGS. 4 to 7 is used in this assembly for light sheet microscopy.

A laser module 1 emits a Gaussian laser beam 2. Said laser beam 2 is expanded by the lenses 3. The diffraction device 4 illuminated by the expanded laser beam 2 comprises an axicon 4.3. The Gaussian laser beam 2 is converted into a Bessel beam 7.1 by means of the axicon 4.3. A collecting optical unit 5 contains a lens used to effect a Fourier transformation of the Bessel beam 7.1, such that the spectrum of the Bessel beam can be seen in the stop plane. With the aid of the stop 6, a filtering is carried out in order to suppress undesired light, e.g. a zero order. Further lenses of the collecting optical unit 5 image the filtered spectrum of the Bessel beam onto a phase plate 8, 8.3, which converts the Bessel beam 7.1 into a modified Bessel beam 10.1 having N primary maxima (N≥2) along an x-direction. The spectrum of the modified Bessel beam 10.1 is imaged onto an xy-scanner 11 with the aid of the lenses 9.1 and 9.2 contained in a further collecting optical unit 9. The combination of lens 12.1 and tube lens 12.2, with the aid of a deflection mirror 13, images the spectrum of the modified Bessel beam 10.1 once again into the pupil of the illumination objective 14. A strip in a sample 15 situated on an object carrier 17 in a sample plane 18 is then illuminated with the scanned modified Bessel beam 10.1. The fluorescence excited by the modified Bessel beam 10.1 in the strip of the sample 15 is forwarded to a detection device 19, which contains an area sensor 20, by means of the detection objective. Said area sensor 20 is used, inter alia, to record an image and to forward said image to a computer.

The features of the invention as mentioned above and explained in various exemplary embodiments can be used here not only in the combinations indicated by way of example, but also in other combinations or by themselves, without departing from the scope of the present invention.

A description related to device features is analogously applicable to the corresponding method with respect to these features, while method features correspondingly represent functional features of the device described.

Even though substantially the use of a Mathieu beam is described in the exemplary embodiments, nevertheless the device presented here and the method presented here are not restricted to Mathieu beams. Device and method can likewise be applied, without restrictions, to Bessel beams and sectioned Bessel beams or other non-diffraction-limited beams. However, the use of a Mathieu beam is preferred on account of its beam properties, such as its advantageous beam profile in an x-y-plane, which has a rapidly decreasing intensity distribution in the y-direction and is thus particularly suitable in principle for generating light sheets of small thickness by means of modification of this output beam profile of the Mathieu beam in comparison with Bessel beams and sectioned Bessel beams.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A beam shaping assembly, comprising
a device for generating a collimated radiation having:
a diffraction device arranged in a spatial domain in the beam path of the collimated radiation, configured for generating a non-diffraction-limited beam;
a collecting function for the Fourier transformation and mapping of the non-diffraction-limited beam into a frequency domain, which is implemented either by the diffraction device or by a collecting optical unit disposed downstream of the diffraction device and containing at least one collecting optical element;
a modification device, arranged in the frequency domain, configured for converting the non-diffraction-limited beam into a modified non-diffraction-limited beam;
a further collecting function for the inverse Fourier transformation of the modified non-diffraction-limited beam from the frequency domain, which is implemented either by the modification device or by a further collecting optical unit disposed downstream of the modification device and containing at least one collecting optical element;
wherein said modified non-diffraction-limited beam contains N primary maxima, where N≥2, along a straight line perpendicular to the direction of propagation of the modified non-diffraction-limited beam.

2. The beam shaping assembly as claimed in claim 1, wherein said diffraction device contains an annular aperture, annular orifice or circular aperture, an axicon or a spatial light modulator (SLM).

3. The beam shaping assembly as claimed in claim 1, wherein said modification device contains a phase element, into which a phase function for generating a modified non-diffraction-limited beam having N primary maxima along a straight line perpendicular to the direction of propagation of the modified non-diffraction-limited beam is coded, wherein the phase element is formed by a phase plate or a spatial light modulator (SLM).

4. The beam shaping assembly as claimed in claim 1, wherein the modification device is configured for converting the non-diffraction-limited beam into a modified non-diffraction-limited beam having N primary maxima along a straight line perpendicular to the direction of propagation of the modified non-diffraction-limited beam and where N≥100, and further comprising a stop for covering half a pupil, which stop is arranged in the frequency domain.

5. A beam shaping assembly, comprising
a device for generating a collimated radiation, having:
a diffraction and modification device in the beam path of the collimated radiation, a spatial light modulator (SLM), arranged in a spatial domain and configured for generating a modified non-diffraction-limited beam and for the Fourier transformation thereof into a frequency domain;
a collecting function for the inverse Fourier transformation of the modified non-diffraction-limited beam from the frequency domain, which is implemented either likewise by the diffraction and modification device or by a collecting optical unit disposed downstream of the diffraction and modification device and containing at least one collecting optical element;
wherein said modified non-diffraction-limited beam contains N primary maxima, where N≥2, along a straight line perpendicular to the direction of propagation of the modified non-diffraction-limited beam.

6. The beam shaping assembly as claimed in claim 1, further comprising a scanner for scanning the modified non-diffraction-limited beam.

7. The beam shaping assembly as claimed in claim 1, wherein the non-diffraction-limited beam is a Bessel beam, a sectioned Bessel beam or a Mathieu beam.

8. The beam shaping assembly as claimed in claim 1, wherein the device for generating a collimated radiation comprises a laser module containing a laser source.

9. The beam shaping assembly as claimed in claim 1, further comprising means for illuminating the diffraction device.

10. The beam shaping assembly as claimed in claim 1, further comprising a stop for filtering undesired light in the frequency domain or in a further frequency domain upstream of the modification device, or in a frequency domain of the diffraction and modification device.

11. A method for beam shaping, for generating a light sheet for light sheet microscopy, comprising:
generating a non-diffraction-limited beam by means of a diffraction device in the beam path of a collimated radiation;
Fourier transformation of the non-diffraction-limited beam into a frequency domain and determining the intensity distribution;
determining the intensity distribution of the modified non-diffraction-limited beam in the frequency domain by calculating the spectrum of the modified non-diffraction-limited beam in the frequency domain taking account of the number of primary maxima N along a straight line perpendicular to the direction of propagation of the modified non-diffraction-limited beam where N≥2 and also the spacing thereof;
determining a phase function of the modified non-diffraction-limited beam in the frequency domain; and
generating a modified non-diffraction-limited beam by using the phase function in a modification device situated in the frequency domain.

12. The method for beam shaping as claimed in claim 11, wherein the generated modified non-diffraction-limited beam is scanned.

13. An assembly for light sheet microscopy, comprising
a sample plane for arranging a sample,
an illumination device containing a beam shaping assembly as claimed in claim 1 for illuminating a strip of the sample and for exciting a fluorescence radiation in said strip of the sample, and
a detection device having a sensor for detecting the fluorescence radiation, an imaging optical unit for imaging the fluorescence radiation of the strip of the sample onto the sensor, and a detection axis, which together with the light sheet forms an angle from an angular range of 70° to 110°, in particular comprising a detection axis perpendicular to the light sheet.

14. The assembly for light sheet microscopy as claimed in claim 13, wherein the detection device contains a stop for a confocal detection.

15. The assembly for light sheet microscopy as claimed in claim 14, wherein the stop is formed as a rolling shutter on the sensor.
